(19) United States
(12) Patent Application Publication
(10) Pub. No.: US 2015/0054792 A1
(43) Pub. Date: Feb. 26, 2015

(54) PROJECTOR

(71) Applicant: FUNAI ELECTRIC CO., LTD., Osaka (JP)

(72) Inventor: Kohei KUKI, Osaka (JP)

(21) Appl. No.: 14/458,539

(22) Filed: Aug. 13, 2014

(30) Foreign Application Priority Data
Aug. 21, 2013 (JP) 2013-171509

(51) Int. Cl. G06F 3/03

(52) U.S. Cl. CPC G06F 3/0325
USPC 345/175

(57) ABSTRACT

Provided is a projector which images first reflected light and second reflected light focused by a condenser lens at a same imaging point on a detector surface of a photodetector, the first reflected light being light reflected off an object at a position a predetermined height above a first region of a projection surface, the second reflected light being light reflected off the object at a position the predetermined height above a second region of the projection surface closer to the photodetector than the first region is.

### CROSS REFERENCE TO RELATED APPLICATION

The present application is based on and claims priority of Japanese Patent Application No. 2013-171509 filed on Aug. 21, 2013. The entire disclosure of the above-identified application, including the specification, drawings and claims is incorporated herein by reference in its entirety.

### FIELD

The present invention relates to projectors, and, more particularly, to a projector which can sense a position of an object such as a touch pen.

### BACKGROUND

Conventionally known projectors project laser light onto a projection surface (for example, see Patent Literature (PTL) 1). The projectors include, for example, a laser light source which outputs light having a red component (R), a laser light source which outputs light having a green component (G), and a laser light source which outputs light having a blue component (B). The projector guides the light output from the respective laser light sources to the projection surface to project an image onto the projection surface. For example, the projector projects an image onto a projection surface on a desk, and when a sensed object, such as a touch pen held by a user or the user's finger, contacts the projection surface, the projector senses reflected light, which is a portion of the light output from the respective laser light sources, reflected off the sensed object. Thus, the position of the sensed object is sensed.

### CITATION LIST

### Patent Literature

[PTL 1] Japanese Patent No. 4872525

### SUMMARY

### Technical Problem

Light reflected off the sensed object passes through a condenser lens and incident on a photodetector such as a photodiode. FIG. 12 is a diagram illustrating a problem of a conventional projector.

A projector 1000 includes a projection unit 30, a photodiode 22A, a condenser lens 25, and a projection surface 100. The projection unit 30 scans laser light R output from a light source (not shown) over the projection surface 100 in a direction oblique to the projection surface 100. The photodiode 22A senses, through a condenser lens 25, light reflected off a touch pen 2 as a sensed object. The condenser lens 25 focuses the reflected light on a point P1 or P2 as an imaging point on a detector surface 22S of the photodiode 22A. The projection unit 30 projects an image onto the projection surface 100.

Hereinafter, an end portion of the projection surface 100 that is close to the photodiode 22A will be referred to as a second end portion 100D, and an end portion of the projection surface 100 that is far away from the photodiode 22A will be referred to as a first end portion 100C. The touch pen 2 having a nib 2A in contact with the second end portion 100D will be referred to as a touch pen 2 (2), and the touch pen 2 having the nib 2A in contact with the first end portion 100C will be referred to as a touch pen 2 (1).

Additionally, positions of the touch pens 2 (1) and 2 (2) a height h2 above the nib 2A will be referred to as positions P5, respectively.

In such a case, assume that light reflected off the touch pen 2 (2) at the point P5 the height h2 above the nib 2A is reflected light r1 and light reflected off the touch pen 2 (1) at the point P5 the height h2 above the nib 2A is reflected light r2, the reflected light r1 and r2 are imaged at the imaging points P1 and P2, respectively, on the detector surface 22S.

In the touch pen 2 (1), reflected light r20 reflected off the touch pen 2 (1) at a point P40 having a height h1 greater than the height h2 is blocked by a mask 22B, due to the presence of the mask 22B, from reaching the detector surface 22S of the photodiode 22A. In the touch pen 2 (2), on the other hand, reflected light r10 reflected off the touch pen 2 (2) at the point P40 reaches the detector surface 22S of the photodiode 22A.

Thus, the heights at which the light reflected off the touch pen 2 (1) and the touch pen 2 (2) reach the photodiode 22A are different. As a result, detector heights, which are heights at which the reflected light can be sensed, are different in the first end portion 100C and the second end portion 100D.

Due to the difference in detector height, for example, when the nib 2A is placed at the point P40 in the second end portion 100D, the reflected light r10 reflected off the nib 2A incident on the detector surface 22S whereas even when the nib 2A is placed at the point P40 in the first end portion 100C, the reflected light r20 reflected off the nib 2A is blocked by the mask 22B, without incident on the detector surface 22S.

As such, if the detector height is different depending on a position of an object (e.g., the touch pen 2) within the projection surface 100, there arises a problem that good ease of use of the projector cannot be obtained.

The present invention is made to solve the above problem and has an object to provide a projector which allows an object to be sensed at a same height.

### Solution to Problem

To achieve the above object, a projector according to one aspect of the present invention is a projector including: a light source for outputting light; a projection unit configured to scan the light output by the light source over a projection surface in a direction oblique to the projection surface to project an image onto the projection surface; a condenser lens for focusing, on an imaging point, reflected light, which is a portion of the light scanned by the projection unit, reflected off an object; a photodetector having a detector surface for sensing the reflected light focused on the imaging point; and a controller which images first reflected light focused by the condenser lens and second reflected light focused by the condenser lens at a same imaging point on the detector surface of the photodetector, the first reflected light being light reflected off the object at a position a predetermined height above a first region of the projection surface, the second reflected light being light reflected off the object at a position the predetermined height above a second region of the projection surface, the second region being closer to the photodetector than the first region is.

According to the above configuration, the first reflected light obtained by the light reflecting off the object in the first region, of the projection surface, which is far away from the photodetector and the second reflected light obtained by the light reflecting off the object in the second region closer to the photodetector than the first region are imaged at a same imaging point.

Thus, the light reflected off the object at points having a certain height above the end portion position of the object is always imaged at the same imaging point throughout a period in which the laser light is scanned over the projection surface from the first region to the second region in a state where the end portion of the object is in contact with the projection surface.

As a result, when the laser light is scanned over the projection surface from the first region to the second region, the light reflected off the object in a certain height range above the projection surface is imaged at the imaging point on the detector surface of the photodetector, without being off the detector surface. Thus, the object anywhere on the projection surface can be sensed always at a same height.

Moreover, the projector may further include a lens moving mechanism for moving the condenser lens in a perpendicular direction to an optical axis direction of the condenser lens, wherein the controller may drive the lens moving mechanism to move the condenser lens in the perpendicular direction to image the first reflected light and the second reflected light at the same imaging point.

In general, the higher the location of the condenser lens the higher the imaging point at which light passed through the condenser lens is imaged. According to the above configuration, the condenser lens is moved in a direction perpendicular to the optical axis to provide control so that the condenser lens is located higher when the object is in the first region than when the object is in the second region.

This can yield the same imaging point in a simple way.

Moreover, the projection unit may scan the light based on a horizontal synchronization signal from the controller, in a direction horizontal to the projection surface, which is a direction perpendicular to a direction from the first region to the second region, and move the light in synchronization with a vertical synchronization signal from the controller, to an adjacent scan line in the direction from the first region to the second region or in a direction from the second region to the first region, and the controller may drive the lens moving mechanism in synchronization with the vertical synchronization signal to move the condenser lens in the direction perpendicular to the optical axis direction.

According to the above configuration, the condenser lens is moved in the direction perpendicular to the optical axis in synchronization with the vertical synchronization signal for moving the light scanned by the projection unit to an adjacent scan line. Thus, as an image is projected onto the projection surface a region of the projection surface where the object can be sensed at the same height extends, and, in its turn, the object can be sensed at a same height anywhere on the projection surface.

The projector may further include: a mirror for reflecting the reflected light focused by the condenser lens; and a mirror rotating mechanism for rotating the mirror about a predetermined rotation axis, wherein the controller may drive the mirror rotating mechanism to rotate the mirror to image the first reflected light and the second reflected light reflected off the mirror at the same imaging point on the detector surface.

According to the above configuration, the mirror is rotated such that the first reflected light and the second reflected light reflected off the mirror are imaged at a same imaging point. Thus, similarly to the foregoing, throughout a period in which the laser light is scanned over the projection surface from the first region to the second region in the state where the end portion of the object is in contact with the projection surface, the light reflected off the object at points having a certain height above the position of the end portion is always imaged at a same imaging point.

As a result, when the laser light is scanned over the projection surface from the first region to the second region, the light reflected off the object in a certain height range above the projection surface is imaged at the imaging point on the detector surface of the photodetector, without being off the detector surface. Thus, the object anywhere on the projection surface can be sensed always at the same height.

Moreover, a projector according to another aspect of the present invention is a projector including: a light source which outputs light; a projection unit configured to scan the light output by the light source over a projection surface in a direction oblique to the projection surface to project an image onto the projection surface; a condenser lens for focusing, on an imaging point, reflected light, which is a portion of the light scanned by the projection unit, reflected off an object; a photodetector having a detector surface, for sensing the reflected light focused on the imaging point; a mask disposed over a portion of the detector surface, for blocking the reflected light; a mask moving mechanism for moving the mask along the detector surface of the photodetector; and a controller which drives the mask moving mechanism to move the mask in synchronization with the projection unit scanning the light over the projection surface to cause reflected light in a predetermined height range above the projection surface to be incident onto the photodetector and block reflected light in a height range above the predetermined height range.

According to the above configuration, the mask is moved in synchronization with scanning the light over the projection surface such that light reflected in a predetermined height range above the projection surface is incident on the photodetector and light reflected above the predetermined height range is blocked.

As a result, anywhere on the projection surface, the photodetector can sense reflected light at a same height above the projection surface.

The present invention may be implemented not only in a projector but also in a method including, as steps, the processing units included in the projector or a program for causing a computer to execute the steps, a computer-readable recording medium such as CD-ROM having stored therein the program, and information, data, or a signal which indicates the program. In addition, the program, information, data, and signal may be distributed via communications network such as the Internet.

### Advantageous Effects

According to the present invention, the object anywhere on the projection surface can be sensed at a same height.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view of an example of an appearance configuration of a projector according to an embodiment 1 of the present invention.

FIG. 2 is a block diagram of a hardware configuration of the projector according to the embodiment 1.

FIG. 3A is a diagram illustrating features of a condenser lens according to the embodiment 1.

FIG. 3B is a diagram illustrating features of the condenser lens according to the embodiment 1.

FIG. 4 is a flowchart illustrating an example of basic operation of the projector according to the embodiment 1.

FIG. 5 is a diagram illustrating effects of the embodiment 1.

FIG. 6 is a block diagram of a hardware configuration of a projector according to an embodiment 2 of the present invention.

FIG. 7 is a flowchart illustrating an example of basic operation of the projector according to the embodiment 2.

FIG. 8A is a diagram illustrating a manner of moving a mask in the embodiment 2.

FIG. 8B is a diagram illustrating a manner of moving the mask in the embodiment 2.

FIG. 9 is a block diagram of a hardware configuration of a projector according to an embodiment 3 of the present invention.

FIG. 10 is a flowchart illustrating an example of basic operation of the projector according to the embodiment 3.

FIG. 11A is a diagram illustrating a rotational manner of a mirror in the embodiment 3.

FIG. 11B is a diagram illustrating a rotational manner of the mirror in the embodiment 3.

FIG. 12 is a diagram illustrating a problem of a conventional projector.

### DESCRIPTION OF EMBODIMENTS

Hereinafter, embodiments according to the present invention will be described, with reference to the accompanying drawings. The embodiments described below are generic and specific illustration of the present invention. Components, arrangement, or connection between the components are merely illustrative and not intended to limit the present invention. Moreover, among the components of the embodiments below, components not set forth in the independent claims indicating the top level concept of the present invention will be described as optional components. In the embodiments described below, a touch pen is by way of example of an object. The present invention, however, is not limited thereto and applicable to any objects in general, which can reflect received light, such as a fingertip, a pencil, a ballpoint, and a fountain pen.

### Embodiment 1

<Projector Configuration>

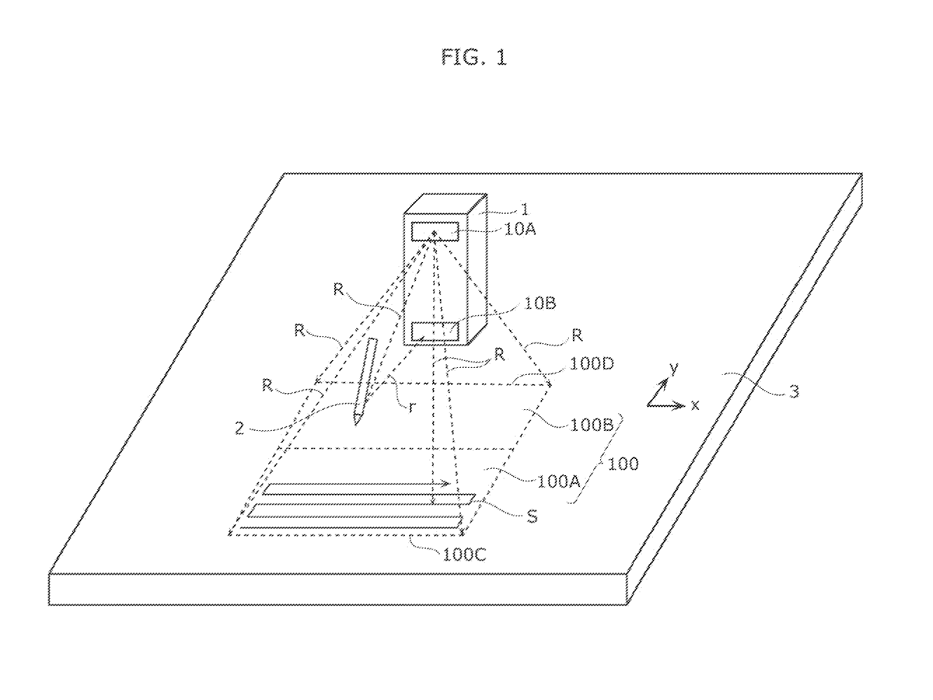

FIG. 1 is a perspective view of an example of an appearance configuration of a projector according to an embodiment 1 of the present invention.

A projector 1 is a device which scans laser light R over a projection surface 100 which is a portion of a flat surface 3 such as a desk surface to project an image onto the projection surface 100. Specifically, assume that the projection surface 100 is divided into a second region 100B close to an entrance 10B and a first region 100A farther away from the entrance 10B than the second region 100B is, the projector 1 scans the laser light R over the first region 100A and the second region 100B in directions oblique to the first region 100A and the second region 100B in a direction from the first end portion 100C of the first region 100A to the second end portion 100D of the second region 100B.

The laser light R is emitted out through an exit 10A and guided to the projection surface 100. When a user contacts a touch pen 2 with the projection surface 100 or places the touch pen 2 within a predetermined distance range above the projection surface 100, reflected light r of the laser light R reflected off the touch pen 2 is incident through the entrance 10B onto the internal of the projector 1. The projector 1 senses a position of the touch pen 2 on or above the projection surface 100, based on the timing of incident of the reflected light r through the entrance 10B onto the internal of the projector 1 in a scanning cycle of the laser light R.

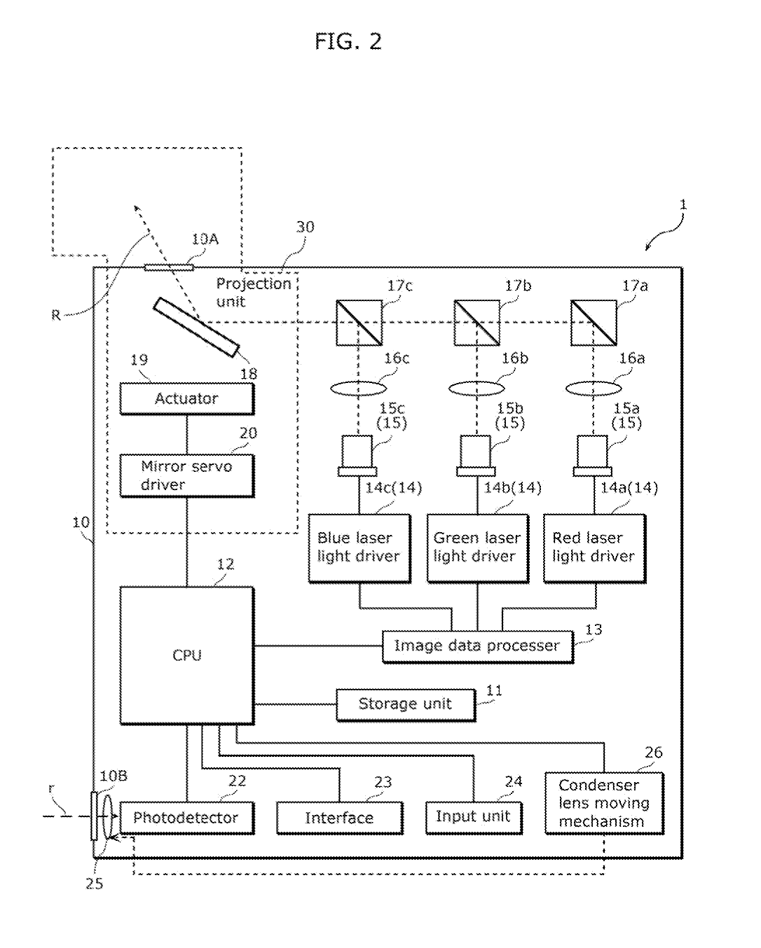

FIG. 2 is a block diagram of a hardware configuration of the projector 1 according to the embodiment 1. The projector 1 includes a storage unit 11, a central processing unit (CPU; a controller) 12, an image data processer 13, a laser drive unit 14 (a red laser light driver 14a, a green laser light driver 14b, and a blue laser light driver 14c), a light source 15 (a red laser light source 15a, a green laser light source 15b, and a blue laser light source 15c), lenses 16a, 16b, and 16c, beam splitters 17a, 17b, and 17c, a projection unit 30, a photodetector 22, an interface 23, an input unit 24, a condenser lens 25, and a condenser lens moving mechanism 26.

The projection unit 30 scans the laser light output from the light source 15 over the projection surface 100 in a direction oblique to the projection surface 100 to project an image onto the projection surface 100. For example, as indicated by an arrow S in FIG. 1, the projection unit 30 scans the laser light R over the projection surface 100, starting from a side farther away from the projector 1 to a side closer to the projector 1. For example, the image has a size of 2000 pixels by 1000 pixels, and the projection unit 30 scans the laser light R along 1000 scan lines provided in a sub-scan direction. Here, a main-scan direction refers to a primary scan direction of the laser light R. In FIG. 1, the x direction is the main-scan direction of the laser light R. The sub-scan direction refers to a direction perpendicular to the main-scan direction. In FIG. 1, the y direction is the sub-scan direction of the laser light R.

The projection unit 30 includes a MEMS (micro electro mechanical systems) mirror 18, an actuator 19, and a mirror servo driver 20.

The storage unit 11 is storing image data to be projected onto the projection surface 100. Based on the image data, the image data processer 13 generates actuation signals of red laser light, green laser light, and blue laser light which are corresponding to a pixel value for each pixel.

The red laser light driver 14a drives the red laser light source 15a, based on the actuation signal of the red laser light generated by the image data processer 13, to cause the red laser light source 15a to emit the red laser light. The green laser light driver 14b drives the green laser light source 15b, based on the actuation signal of the green laser light generated by the image data processer 13, to cause the green laser light source 15b to emit the green laser light. The blue laser light driver 14c drives the blue laser light source 15c, based on the actuation signal of the blue laser light generated by the image data processer 13, to cause the blue laser light source 15c to emit the blue laser light.

The lens 16a is disposed between the red laser light source 15a and the beam splitter 17a on the optical path of the red laser light. The lens 16b is disposed between the green laser light source 15b and the beam splitter 17b on the optical path of the green laser light. The lens 16c is disposed between the blue laser light source 15c and the beam splitter 17c on the optical path of the blue laser light.

The beam splitter 17a changes the optical path of the red laser light that has passed through the lens 16a to guide the red laser light to the beam splitter 17b. The beam splitter 17b changes the optical path of the green laser light that has passed through the lens 16b, and passes therethrough the red laser light guided from the beam splitter 17a. Accordingly, the beam splitter 17b guides laser light that includes the red laser light and the green laser light combined to the beam splitter 17c. The beam splitter 17c changes the optical path of the blue laser light that has passed through the lens 16c, and passes therethrough laser light that includes the red laser light and the green laser light combined which has been guided from the beam splitter 17b. Accordingly, the beam splitter 17c guides the laser light R that includes the red laser light, the green laser light, and the blue laser light combined to the MEMS mirror 18. The laser light R is reflected off the MEMS mirror 18, passes through the exit 10A, and then is guided to the projection surface 100.

The CPU 12 provides generic control over the projector 1, and outputs a horizontal synchronization signal and a vertical synchronization signal to the mirror servo driver 20, for example.

The mirror servo driver 20 and the actuator 19 drive the MEMS mirror 18 to alter the tilt of the MEMS mirror 18 so that the laser light R can rapidly scan over the projection surface 100 in the direction indicated by the arrow S. The mirror servo driver 20 controls the tilt of the MEMS mirror 18 via the actuator 19, based on an indication from the CPU 12.

More specifically, the mirror servo driver 20 reciprocates horizontal oscillation of the MEMS mirror 18 once, in synchronization with the horizontal synchronization signal from the CPU 12, and one line of the image is projected onto the projection surface 100. The mirror servo driver 20 also tilts the MEMS mirror 18 in synchronization with the vertical synchronization signal from the CPU 12 so that an adjacent line of the image in the direction to the second region 100B is projected subsequently onto the projection surface 100. This allows the projection unit 30 to scan the laser light R over the projection surface 100 from the first region 100A to the second region 100B.

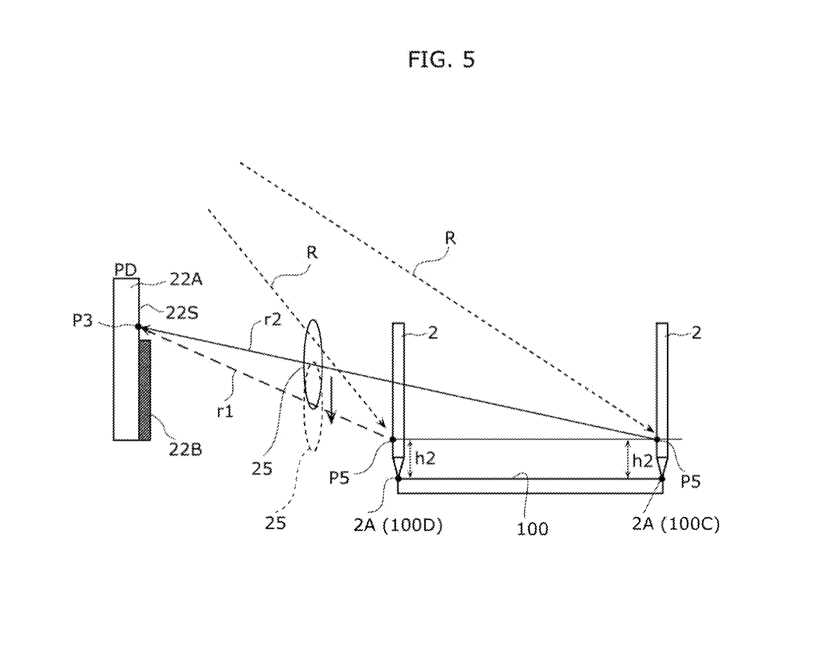

The photodetector 22 senses the reflected light r of the laser light R scanned by the projection unit 30 and reflected off the touch pen 2. The photodetector 22 includes a photodiode 22A (see FIG. 5) which senses the reflected light r.

The photodetector 22 has a photodetection range limited to a predetermined range in a direction perpendicular to the projection surface 100. In other words, to receive the reflected light r which has passed through the entrance 10B, the height at which the photodetector 22 can sense the reflected light r is limited. Specifically, the photodetector is disposed along the detector surface 22S of the photodetector 22 and includes a mask 22B covering a predetermined region of the detector surface 22S of the photodetector 22 (see FIG. 5), as described below.

The CPU 12 locates the touch pen 2. The CPU 12 includes a position sensing unit 121 as a processing unit which is functionally implemented by execution of a program.

The position sensing unit 121 senses, as a position of the touch pen 2, a position where the laser light R is projected by the projection unit 30 at a time instant when the photodetector 22 first senses the reflected light r. For example, if the photodetector 22 senses the reflected light r when the laser light R is projected onto a position represented by coordinates (x1, y1) on the projection surface 100, the position represented by the coordinates (x1, y1) is sensed as the position of the touch pen 2.

The interface 23 connects the projector 1 with an external device. The input unit 24 is a processing unit which receives input of an indication to be given to the CPU 12. The condenser lens 25 focuses, on an imaging point, the light that has reflected off the touch pen 2 and entered the entrance 10B. The condenser lens moving mechanism 26 is configured with a motor or gear mechanism, for example. The condenser lens moving mechanism 26 moves the condenser lens 25 in a direction perpendicular to the reflected light r, namely, downward in response to the CPU 12 causing the projection unit 30 to move the laser light R from the first region 100A to the second region 100B.

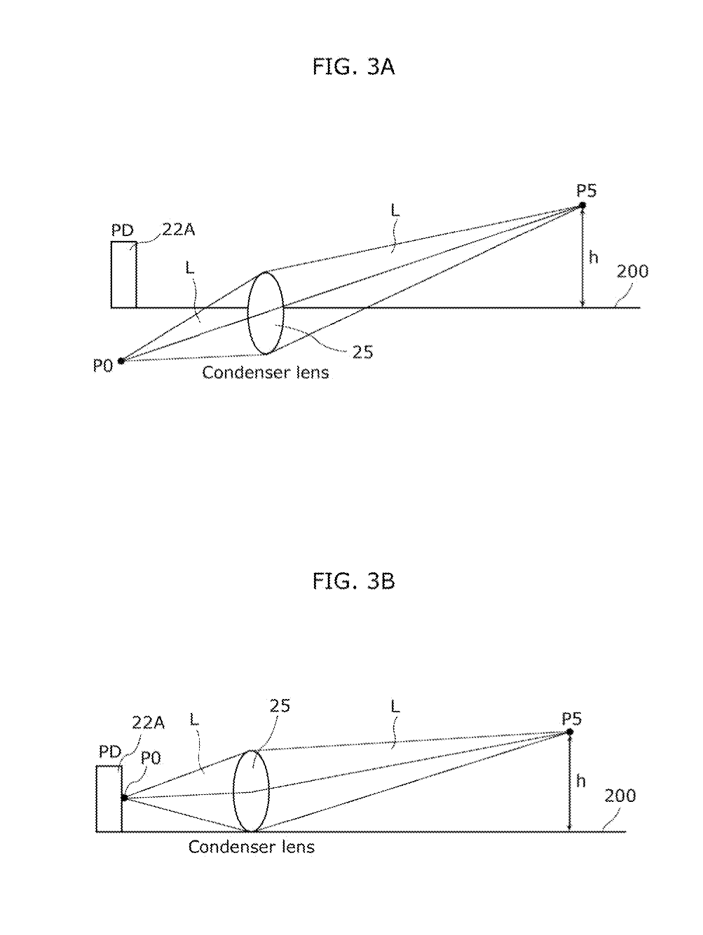

FIGS. 3A and 3B are diagrams illustrating features of the condenser lens 25. As shown in FIGS. 3A and 3B, the condenser lens 25 focuses, on an imaging point P0, reflected light L reflected at the position P5 the height h above a reference plane 200 on which the photodiode 22A is disposed.

At present, as shown in FIG. 3A, when the condenser lens 25 is positioned lower than as indicated in FIG. 3B, the imaging point P0 is located below the photodiode 22A. However, when, as shown in FIG. 3B, the condenser lens 25 is positioned higher than as indicated in FIG. 3A, the imaging point P0 is located on the detector surface 22S of the photodiode 22A. In other words, the imaging point P0 is located higher as the condenser lens 25 moves upward in a direction perpendicular to the reference plane 200, and the imaging point P0 is located lower as the condenser lens 25 moves downward in the direction perpendicular to the reference plane 200. Using such features of the condenser lens 25, the projector 1 performs the following operation.

<Projector Operation>

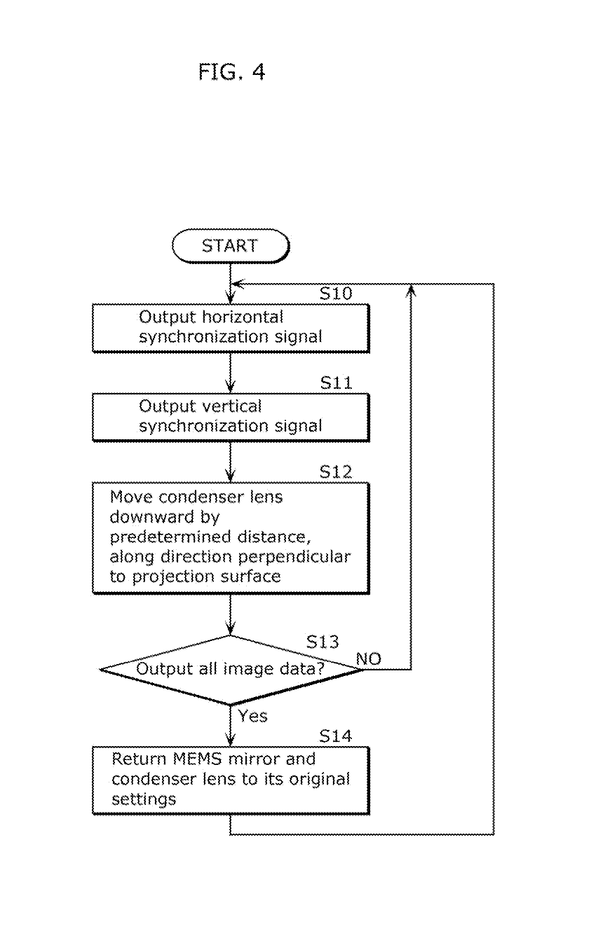

FIG. 4 is a flowchart illustrating an example of basic operation of the projector 1 according to the embodiment 1. It should be noted that, to perform the following processing, it is assumed that such setting is made that the light reflected off the MEMS mirror 18 is directed to the first end portion 100C of the first region 100A of the projection surface 100. Additionally, such setting is made that the condenser lens 25 is at its highest position in the optical direction.

First, the CPU 12 outputs the horizontal synchronization signal to the mirror servo driver 20 to cause the mirror servo driver 20 to reciprocate the horizontal oscillation of the MEMS mirror 18 once (step S10). This projects one line of the image onto the first end portion 100C.

Next, the CPU 12 outputs the vertical synchronization signal to the mirror servo driver 20 to cause the mirror servo driver 20 to tilt the MEMS mirror 18 in the direction to the second end portion 100D so that the light reflected off the MEMS mirror 18 moves to an adjacent scan line in the direction to the second end portion 100D (step S11). This moves the reflected light to an adjacent scan line in the direction to the second end portion 100D and an adjacent line of the image is projected onto the projection surface 100.

Next, the CPU 12 uses the condenser lens moving mechanism 26 to move the condenser lens 25 downward by a predetermined distance, along the direction perpendicular to the projection surface 100 (step S12).

The CPU 12 repeats the previously-described processes of steps S10 to S12 on all the image data stored in the storage unit 11 until the entire image is projected onto the projection surface 100 (NO in step S13). When the processes are completed for all the image data (YES in step S13), the CPU 12 restores the tilt of the MEMS mirror to its original setting (i.e., the setting which directs the light reflected off the MEMS mirror 18 to the first end portion 100C of the first region 100A of the projection surface 100) and the position of the condenser lens 25 to its original setting (i.e., the setting where the condenser lens 25 is at its highest position) (step S14). The CPU 12 then transitions to step S10 to continue the subsequent image projection process.

<Effect of Projector>

FIG. 5 is a diagram illustrating effects of the embodiment 1. In FIG. 5, a dashed line r1 represents light (second reflected light) reflected off the touch pen 2 when a nib 2A of the touch pen 2 is positioned at the second end portion 100D, a solid line r2 represents light (first reflected light) reflected off the touch pen 2 when the nib 2A of the touch pen 2 is positioned at the first end portion 100C.

Since, as previously described, the condenser lens 25 moves downward in synchronization with the vertical synchronization signal, the reflected light focused by the condenser lens 25 when the nib 2A of the touch pen 2 is at the first end portion 100C and when the nib 2A of the touch pen 2 is at the second end portion 100D are imaged on a same imaging point, i.e., an imaging point P3 on the detector surface 22S of the photodiode 22A.

This allows imaging the light reflected off the touch pen 2 at the points P5 a certain height above the position of the nib 2A (the end portion) always at a same imaging point throughout a period in which the laser light R is scanned over the projection surface 100 from the first region 100A to the second region 100B in the state where the nib 2A of the touch pen 2 is in contact with the projection surface 100.

As a result, when the laser light R is scanned over the projection surface 100 from the first region 100A to the second region 100B, the light reflected off the touch pen 2 in a range having a certain height h2 above the projection surface 100 is imaged at the imaging point P3 on the detector surface 22S of the photodiode 22A, without being off the detector surface 22S. Thus, the touch pen 2 anywhere on the projection surface 100 can be sensed at the point P5.

Moreover, since the mask 22B is disposed on the detector surface 22S, extending from an end of the photodiode 22A up until the imaging point P3, light reflected off the touch pen 2 at a point above the point P5 is blocked by the mask 22B from reaching the detector surface 22S. Thus, the presence of the mask 22B can restrict, to the point P5, the height at which the touch pen 2 can be sensed.

### Embodiment 2

<Projector Configuration>

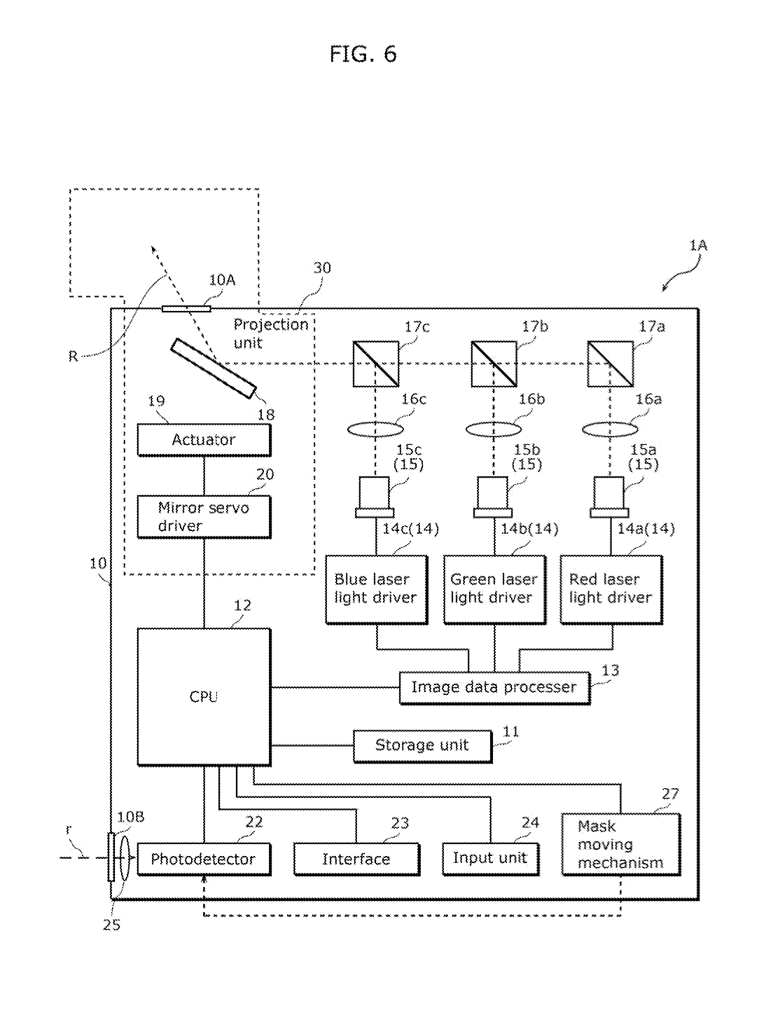

FIG. 6 is a block diagram of a hardware configuration of a projector 1A according to an embodiment 2 of the present invention. The projector 1A further includes, in addition to the components of the projector 1 according to the embodiment 1, a mask moving mechanism 27 for moving a mask 2213 along a detector surface 22S of a photodiode 22A. The mask moving mechanism 27 is, similarly to the condenser lens moving mechanism 26, configured with a motor or gear mechanism, for example.

<Projector Operation>

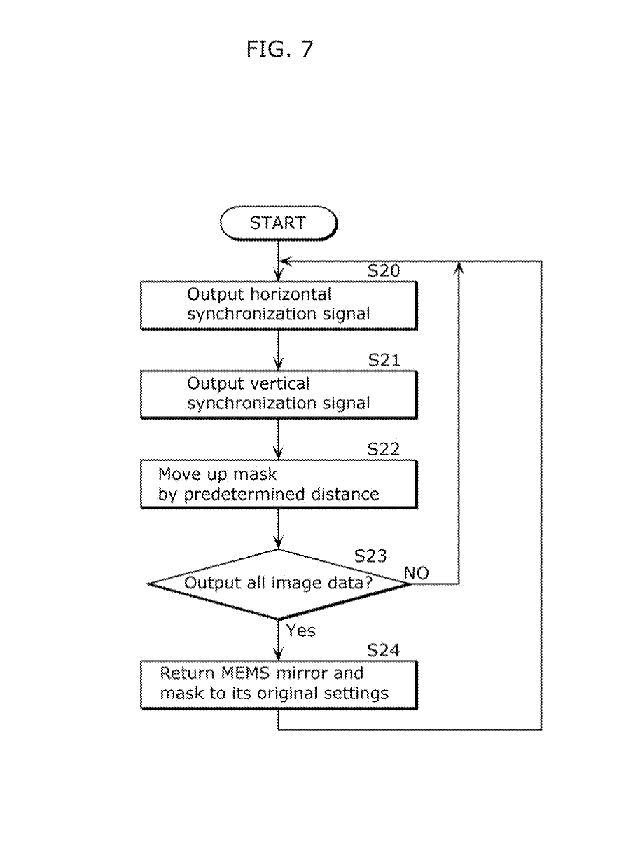

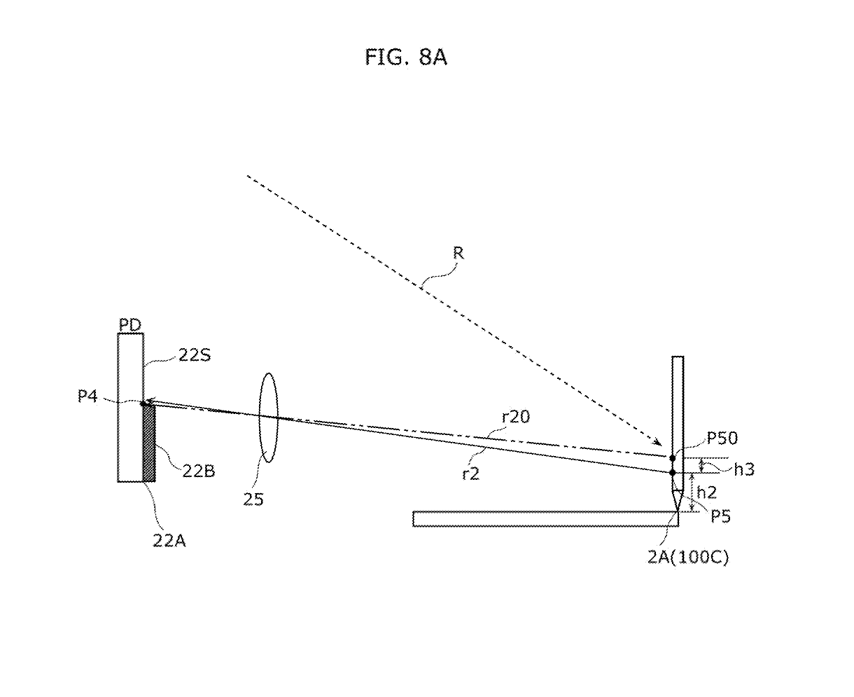

FIG. 7 is a flowchart illustrating an example of basic operation of the projector 1A according to the embodiment 1. It should be noted that, to perform the following processing, it is assumed that such setting is made that light reflected off a MEMS mirror 18 is directed to a first end portion 100C of a first region 100A of a projection surface 100. Additionally, such setting is made that the mask 22B is at its lowest position in the optical direction.

First, a CPU 12 outputs a horizontal synchronization signal to a mirror servo driver 20 to cause the mirror servo driver 20 to reciprocate horizontal oscillation of the MEMS mirror 18 once (step S20). This projects one line of an image onto the first end portion 100C.

Next, the CPU 12 outputs a vertical synchronization signal to the mirror servo driver 20 to cause the mirror servo driver 20 to tilt the MEMS mirror 18 in the direction to a second end portion 100D so that the light reflected off the MEMS mirror 18 moves to an adjacent scan line in the direction to the second end portion 100D (step S21). This moves the reflected light to an adjacent scan line in the direction to the second end portion 100D and an adjacent line of the image is projected onto the projection surface 100.

Next, the CPU 12 uses the mask moving mechanism 27 to move the mask 22B upward by a predetermined distance, in a direction perpendicular to reflected light r (step S22).

The CPU 12 repeats the previously-described processes of steps S20 to S22 on all the image data stored in the storage unit 11 until the entire image is projected onto the projection surface 100 (NO in step S23). When the processes are completed for all the image data (YES in step S23), the CPU 12 restores the tilt of the MEMS mirror to its original setting (i.e., the setting which directs the light reflected off the MEMS mirror 18 to the first end portion 100C of the first region 100A of the projection surface 100) and the position of the mask 22B to its original setting (i.e., the setting where the mask 22B is at its lowest position) (step S24). The CPU 12 then transitions to step S20 to continue the subsequent image projection process.

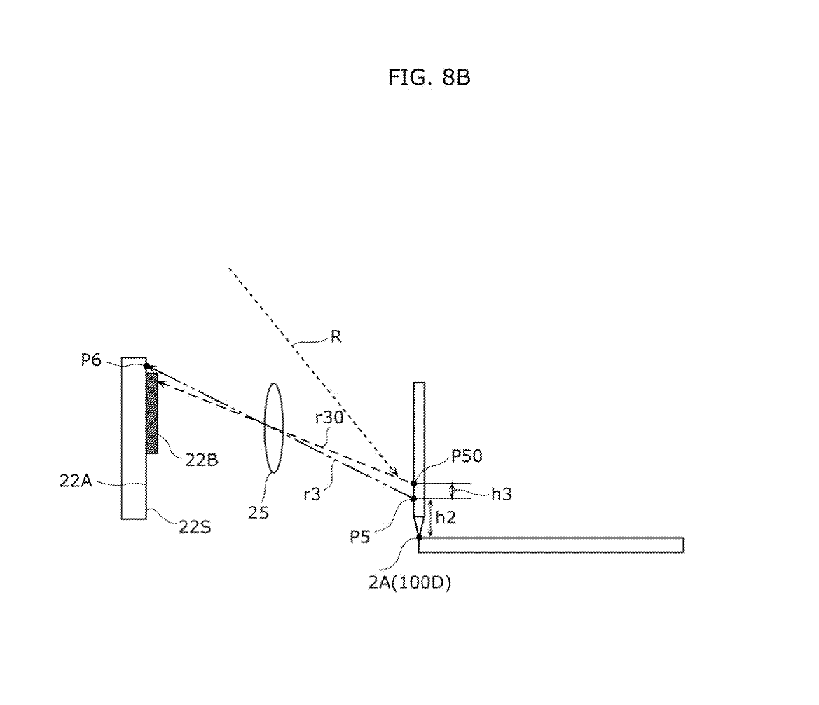

FIGS. 8A and 8B are diagrams illustrating manners of moving the mask 22B. In FIG. 8A, a solid line r2 represents light (first reflected light) reflected off the touch pen 2 at a point P5 a height h2 above the projection surface 100 in a state where a nib 2A of a touch pen 2 is in contact with the first end portion 100C, and a dot-dot-dashed line r20 represents light reflected off the touch pen 2 at a point P50 higher than point P5 by a height h3 in the same conditions as the solid line r2.

In FIG. 8B, a dot-dot-dashed line r3 represents light (second reflected light) reflected off the touch pen 2 at the point P5 the height h2 above the projection surface 100 in the state where the nib 2A of the touch pen 2 is in contact with the second end portion 100D, and a dashed line r30 represents light reflected off the touch pen 2 at the point P50 higher than the point P5 by the height h3 in the same conditions as the dot-dot-dashed line r3.

As shown in FIG. 8A, when laser light R is scanned over the first end portion 100C, a reflected light r2 reflected off the touch pen 2 at the point P5 the height h2 above the nib 2A is imaged at a point P4 on the detector surface 22S of the photodiode 22A as an imaging point P4, whereas the reflected light r20 reflected off the touch pen 2 at the point P50 higher than the point P5 by the height h3 is blocked by the mask 22B from reaching the detector surface 22S.

On the other hand, as shown in FIG. 8B, when the laser light R is scanned over the second end portion 100D, a reflected light r3 reflected off the touch pen 2 at the point P5 the height h2 above the nib 2A is imaged at a point P6 on the detector surface 22S of the photodiode 22A as an imaging point P6, whereas the reflected light r30 reflected off the touch pen 2 at the point P50 higher than the point P5 by the height h3 is blocked by the mask 22B from reaching the detector surface 22S.

<Effect of Projector>

As described above, the mask 22B is moved upward along the detector surface 22S as the laser light R is scanned from the first end portion 100C to the second end portion 100D. Thus, no matter where on the projection surface 100 the laser light R is scanning, the touch pen 2 that is within a height range having the height 2 above the projection surface 100 can be sensed. As a result, the touch pen 2 anywhere on the projection surface 100 can be sensed at the point P5.

### Embodiment 3

<Projector Configuration>

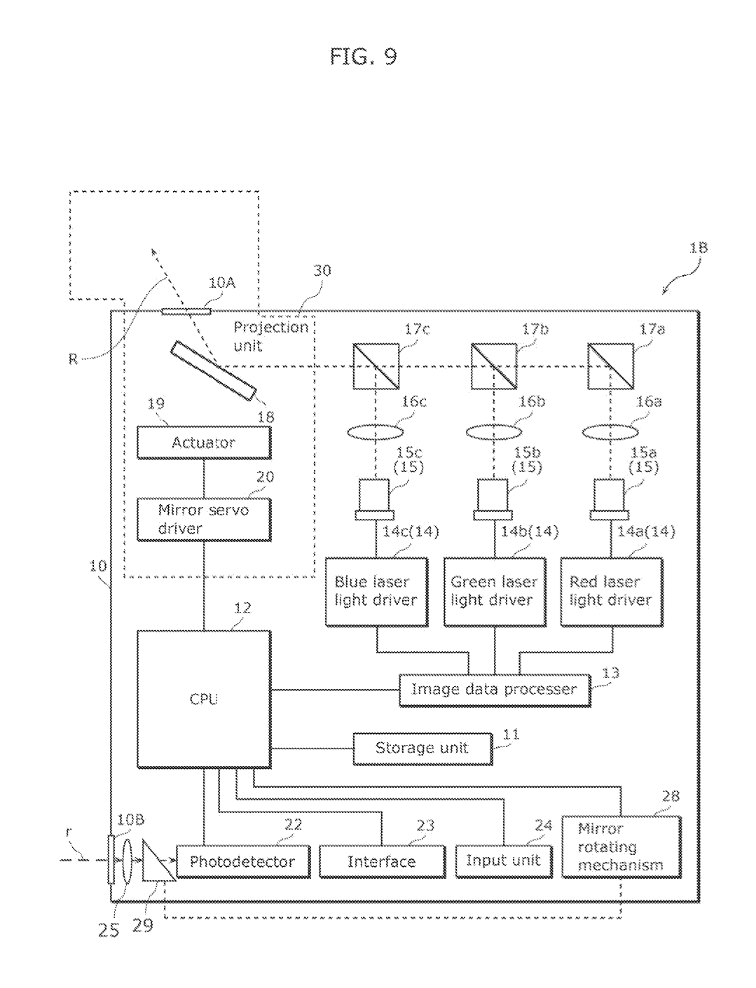

FIG. 9 is a block diagram of a hardware configuration of a projector 1B according to an embodiment 3 of the present invention. The projector 1B further includes, in addition to the components of the projector 1 according to the embodiment 1, a mirror 29 and a mirror rotating mechanism 28. The mirror 29 has a triangular shape and reflects reflected light focused by a condenser lens 25. The mirror rotating mechanism 28 rotates the mirror 29 about a predetermined rotation axis. The mirror rotating mechanism 28 is, similarly to the condenser lens moving mechanism 26, configured with a motor or gear mechanism, for example.

<Projector Operation>

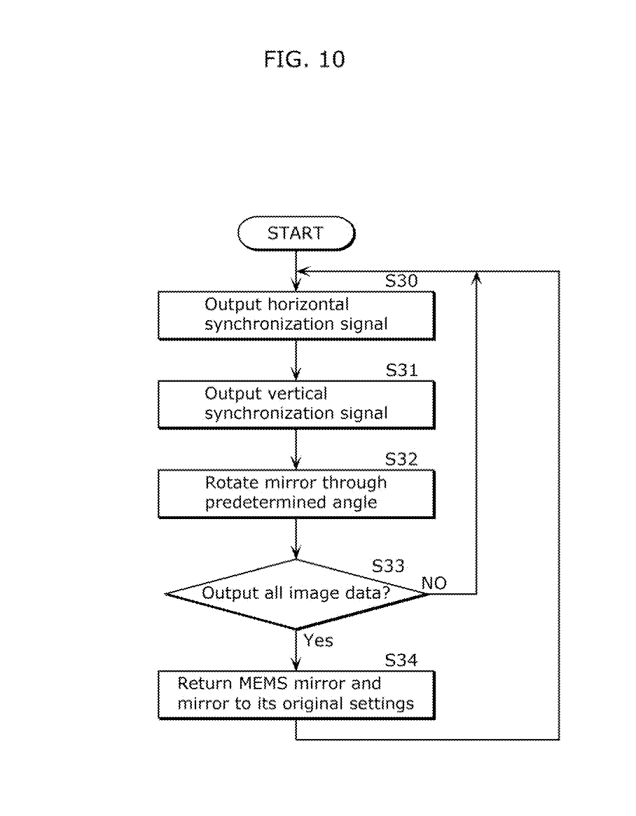

FIG. 10 is a flowchart illustrating an example of basic operation of the projector 1B according to the embodiment 1. It should be noted that, to perform the following processing, it is assumed that such setting is made that light reflected off a MEMS mirror 18 is directed to a first end portion 100C of a first region 100A of a projection surface 100.

Additionally, a degree of rotation of the mirror 29 is set such that reflected light r2 reflected off the mirror 29 is directed to an imaging point P7.

First, a CPU 12 outputs a horizontal synchronization signal to a mirror servo driver 20 to cause the mirror servo driver 20 to reciprocate horizontal oscillation of the MEMS mirror 18 once (step S30). This projects one line of an image onto the first end portion 100C.

Next, the CPU 12 outputs a vertical synchronization signal to the mirror servo driver 20 to cause the mirror servo driver 20 to tilt the MEMS mirror 18 in the direction to a second end portion 100D so that the light reflected off the MEMS mirror 18 moves to an adjacent scan line in the direction to the second end portion 100D (step S31). This moves the reflected light to an adjacent line of the image in the direction to the second end portion 100D and an adjacent line of the image is projected onto the projection surface 100.

Next, the CPU 12 uses the mirror rotating mechanism to rotate the mirror 29 clockwise through a predetermined angle (step S32).

The CPU 12 repeats the previously-described processes of steps S30 to S32 on all the image data stored in the storage unit 11 until the entire image is projected onto the projection surface 100 (NO in step S33). When the processes are completed for all the image data (YES in step S33), the CPU 12 restores the tilt of the MEMS mirror to its original setting (i.e., the setting which directs the light reflected off the MEMS mirror 18 to the first end portion 100C of the first region 100A of the projection surface 100) and the setting of the mirror 29 to its original setting (i.e., the setting where the degree of rotation of the mirror 29 is set so as to direct reflected light r2 reflected off the mirror 29 to the imaging point P7) (step S34). The CPU 12 then transitions to step S30 to continue the subsequent image projection process.

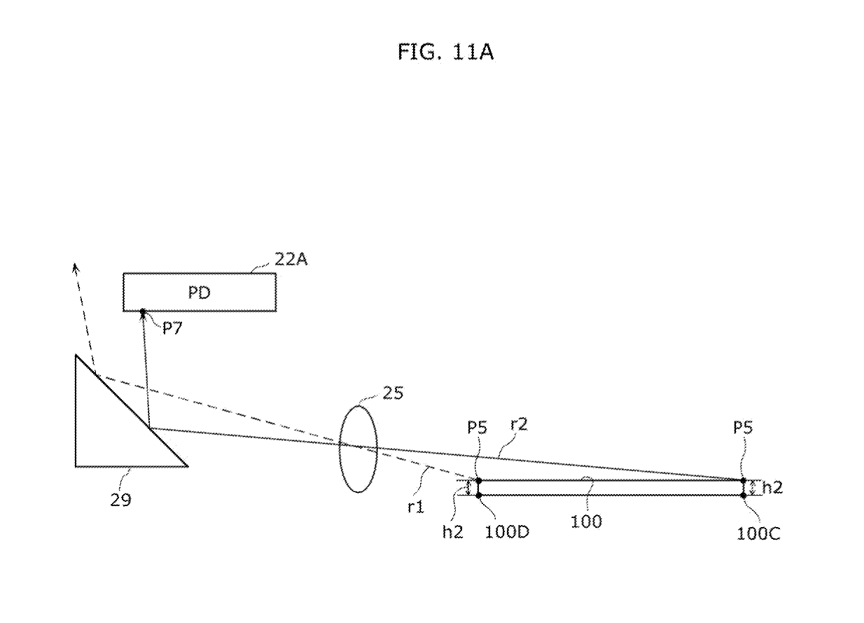

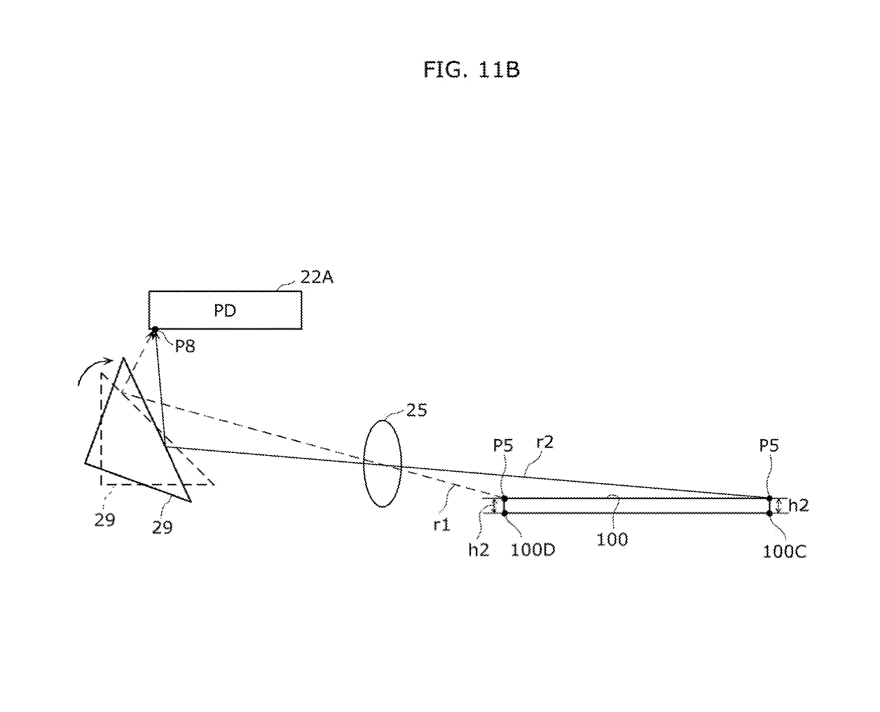

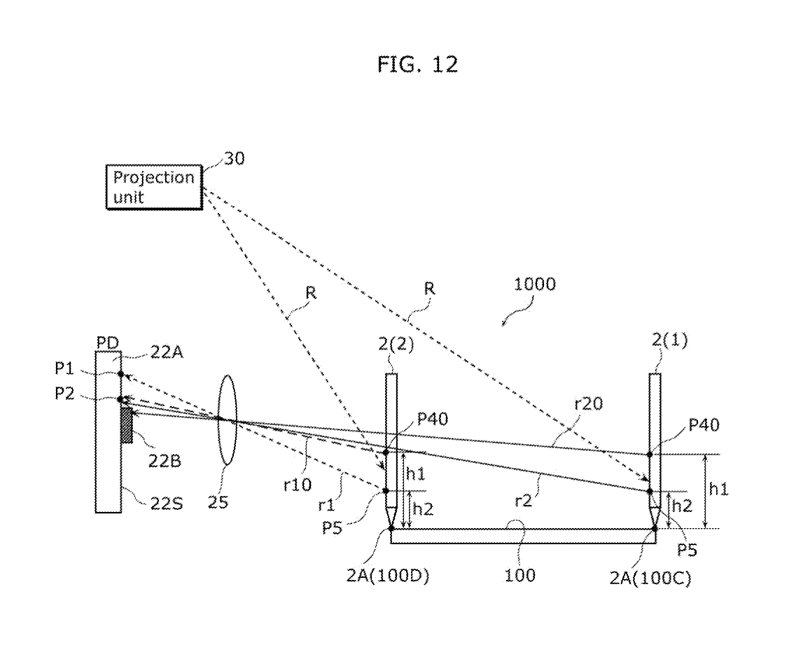

FIGS. 11A and 11B are diagrams illustrating rotational manners of the mirror in the embodiment 3. In FIGS. 11A and 11B, a solid line r2 represents light reflected off the touch pen 2 at a point P5 a height h2 above the projection surface 100 when a nib 2A of a touch pen 2 is in contact with the first end portion 100C, and a dashed line r1 represents light reflected off the touch pen 2 at the point P5 the height h2 above the projection surface 100 when the nib 2A of the touch pen 2 is in contact with the second end portion 100D.

As shown in FIG. 11A, in a state where the mirror 29 is in motionless, the reflected light r2 reflected off the touch pen 2 at the point P5 with the nib 2A in contact with the first end portion 100C is reflected off the mirror 29 and imaged at a point P7 on a photodiode 22A as an imaging point P7. However, with the nib 2A in contact with the second end portion 100D, the reflected light r1 reflected off the touch pen 2 at the point P5 is reflected off the mirror 29, missing the photodiode 22A.

Thus, the touch pen 2 present the height h2 above the projection surface 100 in the first end portion 100C can be sensed whereas the touch pen 2 present the height h2 above the projection surface 100 in the second end portion 100D cannot be sensed. As a result, the heights at which the touch pen 2 can be sensed are different in the first end portion 100C and the second end portion 100D.

On the other hand, in FIG. 11B, the mirror 29 rotates clockwise through a predetermined angle each, as laser light R is directed from the first end portion 100C to the second end portion 100D. As a result, the reflected light r1 and the reflected light r2 are imaged at the same point P8 as an imaging point P8. Thus, the heights at which the touch pen 2 can be sensed are the same, i.e., the point P5 in the first end portion 100C and the second end portion 100D.

<Effect of Projector>

As described above, the light reflected off the touch pen 2 at the points P5 a certain height above the position of the nib 2A can be imaged always at a same imaging point throughout a period in which the laser light R is scanned over the projection surface 100 from the first region 100A to the second region 100B in the state where the nib 2A of the touch pen 2 is in contact with the projection surface 100.

As a result, when the laser light R is scanned over the projection surface 100 from the first region 100C to the second region 100B, the light reflected off the touch pen 2 in a range having a certain height h2 above the projection surface 100 is imaged at the imaging point P8 on the detector surface 22S of the photodiode 22A, without being off the detector surface 22S. Thus, the touch pen 2 anywhere on the projection surface 100 can be sensed at the point P5.

Other

While in the embodiments 1 and 2, the laser light R is scanned in the direction from the first region 100A to the second region 100B, it should be noted that the laser light R may be scanned in a direction from the second region 100B to the first region 100A.

The present invention is not limited to the embodiments. Those skilled in the art will readily appreciate that various modifications are possible in the embodiments without departing from the spirit of the present invention.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to devices in general which project laser light onto a projection surface, such as a desk, to display an image.

1. A projector comprising:
a light source for outputting light;
a projection unit configured to scan the light output by the light source over a projection surface in a direction oblique to the projection surface to project an image onto the projection surface;
a condenser lens for focusing, on an imaging point, reflected light, which is a portion of the light scanned by the projection unit, reflected off an object;
a photodetector having a detector surface for sensing the reflected light focused on the imaging point; and
a controller which images first reflected light focused by the condenser lens and second reflected light focused by the condenser lens at a same imaging point on the detector surface of the photodetector, the first reflected light being light reflected off the object at a position a predetermined height above a first region of the projection surface, the second reflected light being light reflected off the object at a position the predetermined height above a second region of the projection surface, the second region being closer to the photodetector than the first region is.

2. The projector according to claim 1, further comprising
a lens moving mechanism for moving the condenser lens in a perpendicular direction to an optical axis direction of the condenser lens,
wherein the controller drives the lens moving mechanism to move the condenser lens in the perpendicular direction to image the first reflected light and the second reflected light at the same imaging point.

3. The projector according to claim 1,
wherein the projection unit is configured to scan the light based on a horizontal synchronization signal from the controller, in a direction horizontal to the projection surface, which is a direction perpendicular to a direction from the first region to the second region, and move the light in synchronization with a vertical synchronization signal from the controller, to an adjacent scan line in the direction from the first region to the second region or in a direction from the second region to the first region, and
the controller drives the lens moving mechanism in synchronization with the vertical synchronization signal to move the condenser lens in the direction perpendicular to the optical axis direction.

4. The projector according to claim 1, further comprising:
a mirror for reflecting the reflected light focused by the condenser lens; and
a mirror rotating mechanism for rotating the mirror about a predetermined rotation axis,
wherein the controller drives the mirror rotating mechanism to rotate the mirror to image the first reflected light and the second reflected light reflected off the mirror at the same imaging point on the detector surface.

5. A projector comprising:
a light source which outputs light;
a projection unit configured to scan the light output by the light source over a projection surface in a direction oblique to the projection surface to project an image onto the projection surface;
a condenser lens for focusing, on an imaging point, reflected light, which is a portion of the light scanned by the projection unit, reflected off an object;
a photodetector having a detector surface, for sensing the reflected light focused on the imaging point;
a mask disposed over a portion of the detector surface, for blocking the reflected light;
a mask moving mechanism for moving the mask along the detector surface of the photodetector; and
a controller which drives the mask moving mechanism to move the mask in synchronization with the projection unit scanning the light over the projection surface to cause reflected light in a predetermined height range above the projection surface to be incident onto the photodetector and block reflected light in a height range above the predetermined height range.
